(19) United States
(12) Patent Application Publication
(10) Pub. No.: US 2024/0277001 A1
(43) Pub. Date: Aug. 22, 2024

(54) Antioxidant Edible Oil Based on Nano Reverse Micelle System and Preparation Method Thereof

(71) Applicant: Jinan University, Guangzhou (CN)

(72) Inventor: Ying LI, Guangzhou (CN)

(21) Appl. No.: 18/024,782

(22) PCT Filed: Jun. 30, 2022
(86) PCT No.: PCT/CN2022/102584

§ 371 Date: Mar. 6, 2023

(51) Int. Cl. A23D 9/007; A23D 9/04; A23L 27/10

(52) U.S. Cl. CPC A23D 9/007; A23D 9/04; A23L 27/10

(57) ABSTRACT

The disclosure belongs to the technical field of edible oil processing, and particularly relates to a preparation method of a novel antioxidant edible oil based on a nano reverse micelle system. The novel antioxidant edible oil includes the following ingredients: 22.5-100 parts by mass of vegetable oil rich in unsaturated fatty acids (>50 wt %); 0.5-6 parts by mass of edible emulsifier; and 3.75-10 parts by mass of dried natural plant. A vegetable oil-edible emulsifier mixture is used as a solvent to extract natural active ingredients in a natural plant (such as rosemary), and a nano reverse micelle system is formed by self-assembly, such that water-soluble and oil-soluble antioxidants coexist in the oil system, thereby jointly improving oxidation stability of oil. The preparation method of the disclosure is simple, efficient, green and safe, has no organic solvent in the whole process, and is easy for scale-up production.

### TECHNICAL FIELD

The disclosure belongs to the technical field of edible oil processing, and particularly relates to a preparation method of a novel antioxidant edible oil based on a nano reverse micelle system.

### BACKGROUND

Edible oils are essential necessities in people's daily life. During storage or use, edible oils are susceptible to oxidation and quality deterioration due to the influence of light and temperature, and further consumption will endanger people's health.

At present, most of the commercial edible oils on the domestic market are peanut oil, soybean oil, corn oil, rapeseed oil, blended oil, etc. The content of polyunsaturated fatty acids in these oils is low, and especially the ω-3 content is low. This is because ω-3 polyunsaturated fatty acids are highly susceptible to oxidation and have a short shelf life, which is not conducive to the marketing of vegetable oils with high ω-3 content.

In order to ensure the quality stability of edible oils and reduce the susceptibility of edible oils to the environment, synthetic antioxidants such as tert-butyl hydroquinone (TBHQ) are directly added in the market at present to improve the antioxidant performance of edible oils, but synthetic antioxidants have been proved to be toxic and harmful to the human body after long-term consumption. Therefore, there is an urgent need to develop an edible oil that is nutritious and healthy and has stable quality.

Chinese patent application (No. CN 103211281 B) discloses a preparation method of an antioxidant water-in-oil microemulsion. The method includes: adding a peach kernel protein isolate into a phosphate buffer solution to obtain a peach kernel protein isolate emulsion, adding polyglycerol polyricinoleate into raw material oil, uniformly stirring the mixture to obtain an oil liquid, adding the peach kernel protein isolate emulsion into the oil liquid to obtain a mixed coarse emulsion, and then performing high-pressure micro-jet homogenization treatment on the mixed coarse emulsion to obtain the antioxidant water-in-oil microemulsion. The method has certain antioxidant effect, but the conditions required for operation are too complicated and its industrial application is limited.

Chinese patent application (No. CN 107365635 A) discloses a preparation method of an antioxidant oil. The method includes: under the catalytic effect of an immobilized lipase, carrying out reaction on natural phenolic compounds and an edible oil, and after the reaction is completed, filtering the mixture to obtain the antioxidant oil. The method has a certain antioxidant effect, but has the defects of long reaction time, large amount of antioxidant phenols added and high cost.

Chinese patent application (No. CN 108713053 A) discloses a preparation method of an antioxidant oil composition. The oil composition, which is obtained by dispersing a water phase containing certain amounts of water-soluble antioxidant and carbohydrate water-soluble solid ingredient in an oil phase and an oil composition containing a specified amount of water, exhibit excellent oxidation stability. The method has a certain antioxidant effect, but has the defects of single antioxidant ingredient, complex ingredients, high requirements for raw materials and restrictions to operation and its industrial application is limited.

Chinese patent application (No. CN 113015435 A) discloses a preparation method of a microemulsion with an antioxidant. The method includes: mixing an antioxidant with an organic acid and water to produce a water phase, mixing vegetable oil with at least one surfactant to produce a nonpolar phase, and finally mixing the water phase with the nonpolar phase to obtain the microemulsion. The method has a certain antioxidant effect, but has the defects of complex ingredients, high surfactant consumption and inconvenience in operation.

In recent years, active ingredients such as rosmarinic acid, carnosic acid/carnosol and olive polyphenols from natural plant raw materials have been proved to have some antioxidant effect, but little research has been reported on the preparation of antioxidant oils using their nano reverse micelles. Most of the existing methods for extracting natural antioxidants use organic solvents, and have the defects of long time consumption, too many steps required, high cost, great difference in product stability, and great negative effects on the human body and environment due to excessive solvent usage and residues. Taking the rosemary extract as an example, according to the traditional preparation method, different effective antioxidant ingredients such as rosmarinic acid, carnosic acid/carnosol and ursolic acid are extracted by using fossil-derived volatile organic solvents, then concentration, purification and drying are carried out to obtain a powdery product, and finally the powdery product is added to an oil product. Chinese patent application (No. CN 111544922 A) discloses another preparation method of a rosemary extract. The method includes a series of steps: alcohol extraction, concentration, separation, drying, subcritical extraction, decolorization with activated carbon and deodorization (rectification). The obtained rosemary extract is in the form of extractum, and the effect of its addition to edible oil for frying is verified. Although the extraction solvent in this scheme is ethanol and the extraction conditions are relatively mild, the large number of operating units and solvents used, and the single product form (extractum), limit its industrial scale-up production to some extent.

With regard to the above problems and on the basis of the theory that the antioxidant effect of water-soluble antioxidants in oils is better than that of oil-soluble antioxidants, the disclosure prepares a nano reverse micelle system in the oil. According to the disclosure, water-soluble and oil-soluble antioxidant active ingredients are directly extracted from natural plant materials, and are made coexist in an oil system to exhibit a synergistic effect. Thereby, a novel antioxidant edible oil is developed. The oil product obtained by the method of the disclosure can be used directly, and there is no need for the operating units such as concentration, purification, separation, drying and re-addition. The method can greatly reduce the industrial production cost as compared with the prior art, has wide application range, and is applicable to all oxidizable oils.

### SUMMARY

In order to solve the problems in the prior art, the disclosure provides a preparation method of a novel antioxidant edible oil based on a nano reverse micelle system and application thereof. The edible oil is free of synthetic antioxidants, and has the advantages of high safety, good thermal stability and high feasibility of scale-up production. The construction of self-assembled nano reverse micelles provides a new method for extracting a water-soluble antioxidant with an oil solvent. Finally, based on the theory that the antioxidant effect of water-soluble antioxidants in oils is better than that of oil-soluble antioxidants, the disclosure verifies that the water-soluble antioxidant has better effect than the oil-soluble antioxidant in an oil system.

The technical scheme of the disclosure is: an antioxidant edible oil based on a nano reverse micelle system, including the following ingredients: 22.5-100 parts by mass of vegetable oil rich in unsaturated fatty acids; 0.5-6 parts by mass of edible emulsifier; and 3.75-10 parts by mass of rosemary.

Further, the edible emulsifier is one of lecithin, polyglycerol ricinoleate, diglyceride and saturated/unsaturated glycerol monostearate.

Further, the dried natural plant is one or two of rosemary, olive leaves and other raw materials rich in antioxidant active ingredients.

Further, a total content of unsaturated fatty acids in the vegetable oil rich in unsaturated fatty acids is greater than 50 wt %. The vegetable oil rich in unsaturated fatty acids is one of flaxseed oil, sunflower seed oil, perilla seed oil, peony seed oil, sacha inchi oil and other oxidizable vegetable oils.

The disclosure further provides a preparation method of the novel antioxidant edible oil based on a nano reverse micelle system, including the following steps:
step (1): uniformly mixing a vegetable oil and an edible emulsifier, and dissolving the edible emulsifier by stirring until the system is stable, thereby obtaining a vegetable oil-edible emulsifier compound oil sample; and
step (2): adding dried rosemary into the vegetable oil-edible emulsifier compound oil sample obtained in step (1), extracting antioxidant ingredients in the natural plant, carrying out centrifuging, and taking the supernatant.

Further, the extraction in step (2) is one or more of stirring, ultrasound or microwave-assisted extraction.

Further, a mass ratio of the vegetable oil to the edible emulsifier in step (1) is (10-100):1.

Further, the stirring in step (1) is carried out for 5-48 h at a speed of 500-1000 r/min.

Further, a mass ratio of the dried natural plant to the vegetable oil-edible emulsifier compound oil sample in step (2) is 1:(5-21).

Further, the extraction in step (2) is carried out for 0.1-3 h.

In the antioxidant edible oil provided by the disclosure, the vegetable oil rich in unsaturated fatty acids contains not only the main ingredient triglyceride, but also trace ingredients such as phospholipids, sterols, diglycerides and free fatty acids. The trace ingredients are mostly amphiphilic molecules that have surface activity and belong to endogenous food emulsifiers. It has been found that when using vegetable oils to directly perform extraction on the dried natural plant, these amphiphilic molecules meet with water and the antioxidant active ingredients in the natural plant and self-assemble to form micelle structures of different shapes and sizes, and a water core that can be used to dissolve water-soluble antioxidants is formed in each micelle structure. Due to the limited content of the endogenous amphiphilic molecules, in order to promote the generation of more self-assembled micelles and maximally extract the natural active ingredients, exogenous amphiphilic molecules (with a hydrophilic-lipophilic balance of less than 8) lecithin, polyglycerol ricinoleate, diglyceride and saturated/unsaturated glycerol monostearate are inventively added. Especially when the mass ratio of the vegetable oil to the edible emulsifier is (10-100):1, the generation of the self-assembled micelles can be effectively improved, so that the oil-soluble and water-soluble natural antioxidant active molecules stably coexist in the oil system, thereby achieving the synergistic antioxidant effect. It is also verified through experiments that as can be seen from the small-angle X-ray scattering spectrum in Test Example I, by characterizing the oil system using small-angle X-ray scattering, it is confirmed that the micelle morphology in the example of the disclosure has changed from heterogeneous and irregular shape (>15 nm) before extraction to circular reverse micelles (˜2-3 nm) after extraction, indicating that the nano reverse micelle system in the examples has been successfully self-assembled and the natural antioxidants have been successfully extracted and embedded in the nano reverse micelle system.

In addition, it has been proved through experiments that the antioxidant effect of the novel antioxidant edible oil based on the nano reverse micelle system in the disclosure is better than the traditional direct addition of antioxidants (such as TBHQ) and better than the addition of antioxidant active ingredients from natural plants alone.

Compared with the prior art, the preparation method of the novel antioxidant edible oil based on a nano reverse micelle system has the following advantages:
(1) According to the disclosure, the edible vegetable oil-edible emulsifier compound oil sample is used to perform extraction on the dried natural plant to prepare the novel antioxidant edible oil containing a nano reverse micelle system, which fully displays the bioactivity of antioxidant ingredients in the dried natural plant and can effectively slow down the oxidation process of the vegetable oil. For example, the main natural antioxidant ingredients in the rosemary, including rosmarinic acid, carnosol/carnosic acid and ursolic acid, all have strong antioxidant activity. According to the preparation method of the disclosure, the specific emulsifier and vegetable oil are used to form the self-assembled micelles, so that the water-soluble and oil-soluble antioxidant ingredients in the rosemary can be extracted at the same time, and coexist in the edible oil in the form of nano reverse micelles, thereby solving the problem that molecules with different polarities are mutually insoluble and developing the novel antioxidant edible oil.
(2) In the preparation method of the disclosure, no organic solvent is used, and all the additives are food-grade natural products that are green and safe. The preparation method is simple to operate, low in production cost and easy for scale-up production.
(3) The preparation method of the novel antioxidant oil does not damage the nutrients in the edible oil, and the novel antioxidant oil can be directly eaten or used for food processing.

### BRIEF DESCRIPTION OF FIGURES

FIG. 1 is a flowchart of a preparation method of the disclosure;

FIG. 2(a) is a small-angle X-ray scattering spectrum of Example 1, and (b) is a fitting diagram of formation of a nano reverse micelle structure;

FIG. 3 is a diagram showing changes of the small-angle X-ray scattering spectrum of a nano reverse micelle structure in sunflower seed oil obtained in Example 4; and

FIG. 4 is a model of the nano reverse micelle system formed by the sunflower seed oil obtained in Example 4.

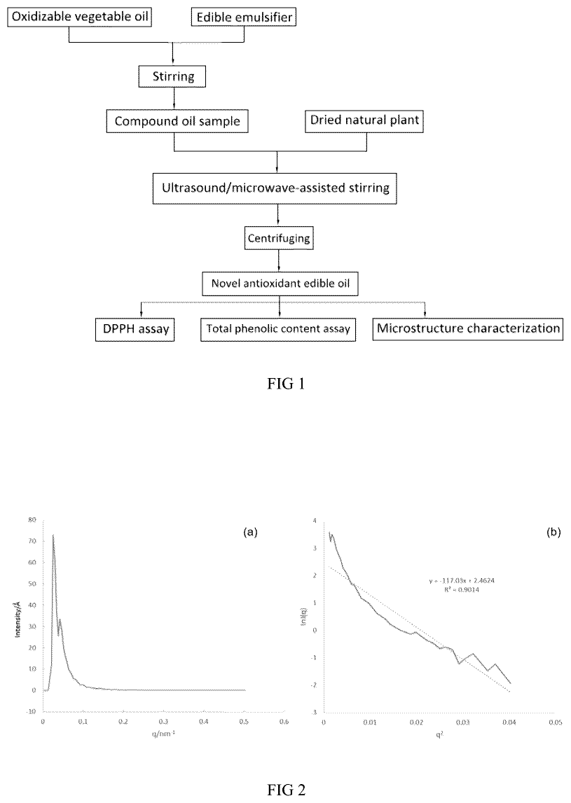

### DETAILED DESCRIPTION

The disclosure will be further illustrated below by the description of specific embodiments, but this is not a limitation to the disclosure. Those skilled in the art can make various modifications or improvements according to the basic idea of the disclosure. However, these modifications or improvements are all within the protection scope of the disclosure as long as they do not deviate from the basic idea of the disclosure.

Reagents used in the disclosure are all common reagents that can be purchased from conventional reagent production and sales companies.

### Example 1: Preparation Method of Novel Antioxidant Flaxseed Oil Based on Nano Reverse Micelle System

Step (1): 1 g of glycerol monostearate was added to 25 g of edible flaxseed oil, and the mixture was stirred at 600 r/min for 12 h. The dissolution uniformity of the glycerol monostearate in the edible flaxseed oil was observed, and the stirring may be continued until there was no precipitate.
Step (2): 5 g of dried rosemary was added to the mixture in step (1), ultrasound-assisted extraction was carried out for 15 min, the resulting mixture was centrifuged at 6000 rpm for 5 min, and the supernatant was taken.

### Example 2: Preparation Method of Novel Antioxidant Flaxseed Oil Based on Nano Reverse Micelle System

Step (1): 4 g of polyglycerol ricinoleate was added to 50 g of edible flaxseed oil, and the mixture was stirred at 600 r/min for 12 h. The dissolution uniformity of the polyglycerol ricinoleate in the edible flaxseed oil was observed, and the stirring may be continued until there was no precipitate.
Step (2): 5 g of dried rosemary was added to the mixture in step (1), stirring was carried out at 800 r/min for 1 h, the resulting mixture was centrifuged at 6000 rpm for 5 min, and the supernatant was taken.

### Example 3: Preparation Method of Novel Antioxidant Flaxseed Oil Based on Nano Reverse Micelle System

Step (1): 6 g of lecithin was added to 100 g of edible flaxseed oil, and the mixture was stirred at 600 r/min for 12 h. The dissolution uniformity of the lecithin in the edible flaxseed oil was observed, and the stirring may be continued until there was no precipitate.
Step (2): 10 g of dried rosemary was added to the mixture in step (1), microwave-assisted extraction was carried out at 800 r/min for 20 min, the resulting mixture was centrifuged at 6000 rpm for 5 min, and the supernatant was taken.

### Example 4: Preparation Method of Novel Antioxidant Sunflower Seed Oil Based on Nano Reverse Micelle System

Step (1): 1.25 g of lecithin was added to 22.5 g of refined sunflower seed oil, and the mixture was stirred at 600 r/min for 3 h. The dissolution uniformity of the lecithin in the edible sunflower seed oil was observed, and the stirring may be continued until there was no precipitate.
Step (2): 3.75 g of dried olive leaves was added to the mixture in step (1), stirring was carried out at 800 r/min for 1 h, the resulting mixture was centrifuged at 6000 rpm for 5 min, and the supernatant was taken.

### Example 5: Preparation Method of Novel Antioxidant Flaxseed Oil Based on Nano Reverse Micelle System

Step (1): 0.5 g of glycerol monostearate was added to 50 g of edible flaxseed oil, and the mixture was stirred at 600 r/min for 12 h. The dissolution uniformity of the glycerol monostearate in the edible flaxseed oil was observed, and the stirring may be continued until there was no precipitate.
Step (2): 2.5 g of dried rosemary was added to the mixture in step (1), ultrasound-assisted extraction was carried out for 20 min, the resulting mixture was centrifuged at 6000 rpm for 5 min, and the supernatant was taken.

### Example 6: Preparation Method of Novel Antioxidant Flaxseed Oil Based on Nano Reverse Micelle System

Step (1): 2.5 g of glycerol monostearate was added to 25 g of edible flaxseed oil, and the mixture was stirred at 600 r/min for 12 h. The dissolution uniformity of the glycerol monostearate in the edible flaxseed oil was observed, and the stirring may be continued until there was no precipitate.
Step (2): 5 g of dried rosemary was added to the mixture in step (1), ultrasound-assisted extraction was carried out for 10 min, the resulting mixture was centrifuged at 6000 rpm for 5 min, and the supernatant was taken.

### Comparative Example 1: Conventional Edible Oil

0.02% by mass of TBHQ was added to flaxseed oil, and the mixture was stirred at 600 r/min until the TBHQ was dissolved.

### Comparative Example 2: Preparation Method of Novel Antioxidant Flaxseed Oil Based on Nano Reverse Micelle System

The preparation method of Comparative Example 2 was similar to that in Example 1. The difference from Example 1 was that the vegetable oil used was castor oil.

### Comparative Example 3: Preparation Method of Novel Antioxidant Flaxseed Oil Based on Nano Reverse Micelle System

The preparation method of Comparative Example 3 was similar to that in Example 1. The difference from Example 1 was that the emulsifier used was Tween 80 with a hydrophilic-lipophilic balance of greater than 10.

### Comparative Example 4: Preparation Method of Novel Antioxidant Flaxseed Oil Based on Nano Reverse Micelle System

The preparation method of Comparative Example 4 was similar to that in Example 1. The difference from Example 1 was that: the amount of the flaxseed oil was 20 g, the amount of the dried rosemary was 0.5 g, and the amount of the emulsifier was 0.1 g; the mass ratio of the vegetable oil to the edible emulsifier was 200:1; and the mass ratio of the rosemary to the vegetable oil-edible emulsifier compound was 1:40.

### Comparative Example 5: Preparation Method of Novel Antioxidant Flaxseed Oil Based on Nano Reverse Micelle System

The preparation method of Comparative Example 5 was similar to that in Example 1. The difference from Example 1 was that: the amount of the flaxseed oil was 50 g, the amount of the dried rosemary was 2 g, and the amount of the emulsifier was 8 g; the mass ratio of the vegetable oil to the edible emulsifier was 25:4; and the mass ratio of the rosemary to the vegetable oil-edible emulsifier compound was 1:25.

### Test Example I: Microstructure Characterization of Nano Reverse Micelles

1. Test subjects: Vegetable oils obtained in Examples 1 and 4 and Comparative Examples 2 to 5.
2. Test method: The structural changes of the micelle system in the edible oil were detected by small-angle X-ray scattering using Mo radiation (λ=0.71 Å). The scattered beam was recorded using a large on-line scanning detector with a diameter of 345 mm, and q was in the range of 3.10⁻² to 2.5 Å⁻¹. The scattering intensity was expressed as q=[(4π)/λ]×sin(θ/2). A was the wavelength of the incident radiation, and θ was the scattering angle. Quartz capillaries for containing the oil sample had a diameter of 2 mm.
3. Test results:

The changes of the micelle system of the flaxseed oil in Example 1 of this application before and after ultrasound-assisted extraction on the dried rosemary were detected using the above test method. As shown in FIG. 2, a strong scattering signal was found when q was less than 2 nm⁻¹, indicating the presence of polymers in the oil sample. As can be seen from the curve obtained according to Guinier Law, the spherical reverse micelle structures having a size of about 2.5 nm were formed after the extraction.

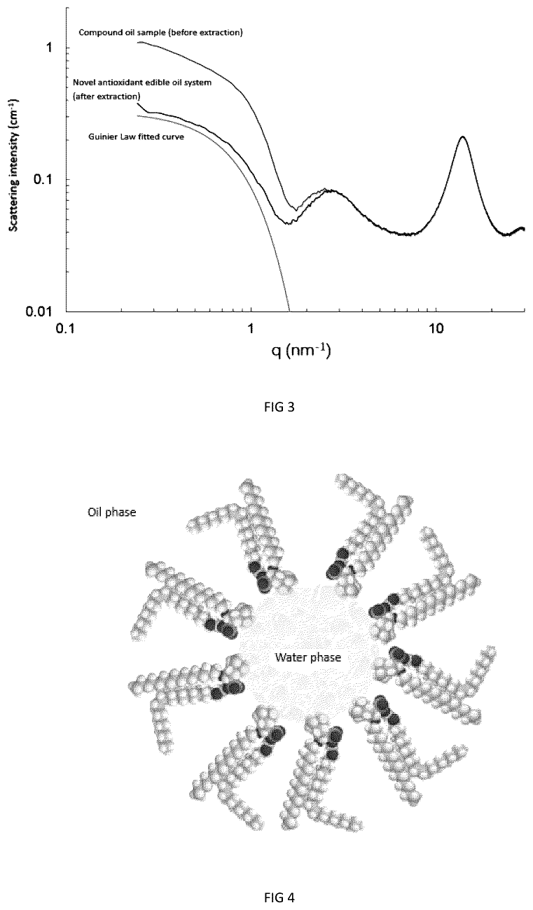

The changes of the micelle system of the refined sunflower seed oil in Example 4 of this application before and after extraction on the dried olive leaves were detected using the above test method. As shown in FIG. 3, a strong scattering signal was found when q was less than 2 nm⁻¹, indicating the presence of polymers in the oil sample. Before the extraction, the scattering spectrum at less than 2 nm⁻¹ exhibited typical features of heterogeneous polymers (long, bar and oval), and the size was about 17 nm, which was much larger than that of lecithin polymer (2.5-3 nm), so it was presumed to be the morphology of reverse micelles in which the water core had a diameter of at least 10 nm. After the extraction, as can be seen from the curve obtained according to Guinier Law, the morphology of the heterogeneous polymer had changed into non-interactive spherical polymer whose size had dropped to about 5 nm. The result indicated that once the self-assembled reverse micelles were formed, the heterogeneous polymer in the oil would change from a disordered structure to an ordered structure at the start of the extraction, and the content of the antioxidant extract in the water core could control this change and the size of the circular reverse micelles.

The vegetable oils obtained in Comparative Example 2, Comparative Example 3 and Comparative Example 4 could not form micelles. The vegetable oil obtained in Comparative Example 5 could form micelles, but the system was not stable due to the small amount and volume of the micelles.

### Test Example II: Total Phenolic Content Assay

1. Test subjects: Vegetable oils obtained in Examples 1 to 6 and Comparative Examples 1 to 5.
2. Test method: 2.5 g of the vegetable oil obtained in Examples 1 to 6 and Comparative Examples 1 to 5 were dissolved in 2.5 ml of n-hexane, followed by the addition of 1 ml of methanol/H₂O (80:20, v/v). The sample was vortexed for 4 min and centrifuged for 5 min at 2880×g and 4° C. The extraction and the centrifuging were carried out three times until the final volume was 3 ml of water phase. The extracted sample was washed with n-hexane, and then the total phenolic content was determined by a Folin-phenol reagent method. The results were expressed in mg gallic acid equivalent (mg GAE)/g oil.
3. Test results:

The test results are shown in Table 1:

TABLE 1
Total phenolic content assay.

| | | | | | | | Comparative | Comparative | Comparative | Comparative | Comparative |
|---|---|---|---|---|---|---|---|---|---|---|---|
| | Example | Example | Example | Example | Example | Example | Example | Example | Example | Example | Example |
| Group | 1 | 2 | 3 | 4 | 5 | 6 | 1 | 2 | 3 | 4 | 5 |
| Total | 60.27 | 50.61 | 45.86 | 53.59 | 42.27 | 50.25 | 20.37 | 34.75 | 32.57 | 21.35 | 25.43 |
| phenolic | | | | | | | | | | | |
| content | | | | | | | | | | | |
| (mg GAE)/g | | | | | | | | | | | |

It was found through the above test method that the flaxseed oil or the refined sunflower seed oil with the emulsifier and the dried rosemary had a certain antioxidant capacity. As shown in Table 1, in the case that the nano reverse micelle system of the disclosure was used, the oxidation stability of the flaxseed oil or the refined sunflower seed oil obtained in Examples 1 to 6 was apparently higher than that of the oil with the synthetic antioxidant TBHQ (Comparative Example 1). In Comparative Example 2 where the vegetable oil used was the castor oil, the total phenolic content was only 34.75 (mg GAE)/g. In Comparative Example 3 where the emulsifier used was the Tween 80 with a hydrophilic-lipophilic balance of greater than 10, the total phenolic content was only 32.57 (mg GAE)/g. Besides, when the ratio of the emulsifier to the vegetable oil or the ratio of the dried plant to the vegetable oil-edible emulsifier compound oil sample was changed, the total phenolic content in Comparative Example 4 and Comparative Example 5 was also much lower than that in the examples. The antioxidant vegetable oil obtained in Comparative Example 5 could form micelles, but the system was not stable due to the small amount and volume of the micelles, so the total phenolic content detected was only 25.43 (mg GAE)/g.

As a result, the usage of the oil with a high polyunsaturated fatty acid content was limited in many cases because of its low oxidation stability, but it could be used as a conventional oil by using the nano reverse micelle system of the disclosure.

### Test Example III: DPPH Radical Scavenging Rate Assay

1. Test subjects: Vegetable oils obtained in Examples 1 to 6 and Comparative Examples 1 to 5.
2. Test method: 240 mg of the vegetable oil obtained in Examples 1 to 6 and Comparative Examples 1 to 5 were dissolved in methanol to a concentration of 40000 ppm (w/v), and the mixture was mixed for 1 min and centrifuged at 2208×g for 3 min. Then, 0.25 ml of supernatant was reacted with 0.75 ml of 0.1 mM DPPH in methanol. After the reaction was carried out for 30 min in the dark, the absorbance of the sample mixture at 517 nm was measured. The absorbance of DPPH was expressed as DPPH loss.
3. Test results:

The test results are shown in Table 2:

TABLE 2
DPPH radical scavenging rate

| | | | | | | | Comparative | Comparative | Comparative | Comparative | Comparative |
|---|---|---|---|---|---|---|---|---|---|---|---|
| | Example | Example | Example | Example | Example | Example | Example | Example | Example | Example | Example |
| Group | 1 | 2 | 3 | 4 | 5 | 6 | 1 | 2 | 3 | 4 | 5 |
| Scavenging | 63.82 | 59.32 | 57.35 | 60.83 | 55.72 | 59.04 | 35.11 | 40.84 | 38.25 | 36.26 | 37.94 |
| rate (%) | | | | | | | | | | | |

As shown in Table 2, in the case that the nano reverse micelle system of the disclosure was used, the DPPH scavenging rate of the vegetable oil obtained in Examples 1 to 6 was apparently higher than that in Comparative Example 1 where the synthetic antioxidant TBHQ was added, in Comparative Example 2 where the castor oil was used, in Comparative Example 3 where the emulsifier was the Tween 80, and in Comparative Examples 4 and 5. This indicated that the oxidation resistance of the novel edible oil containing the nano reverse micelle system was significantly improved, which was consistent with the result of the total phenolic content assay.

The above examples merely exemplarily illustrate the principles and effects of the disclosure, but are not intended to limit the disclosure. Any person skilled in the art can modify or change the above examples without departing from the spirit and scope of the disclosure. Therefore, all equivalent modifications or changes made by those of ordinary skill in the art without departing from the spirit and technical ideas disclosed in the disclosure should still be covered by the claims of the disclosure.

What is claimed is:

1. An antioxidant edible oil based on a nano reverse micelle system, comprising the following ingredients: 22.5-100 parts by mass of vegetable oil rich in unsaturated fatty acids; 0.5-6 parts by mass of edible emulsifier; and 3.75-10 parts by mass of dried natural plant.

2. The antioxidant edible oil based on a nano reverse micelle system according to claim 1, wherein the edible emulsifier is one of lecithin, polyglycerol ricinoleate, diglyceride and saturated/unsaturated glycerol monostearate.

3. The antioxidant edible oil based on a nano reverse micelle system according to claim 1, wherein the dried natural plant is one or two of rosemary and olive leaves.

4. The antioxidant edible oil based on a nano reverse micelle system according to claim 1, wherein a total content of unsaturated fatty acids in the vegetable oil rich in unsaturated fatty acids is greater than 50 wt %.

5. The antioxidant edible oil based on a nano reverse micelle system according to claim 1, wherein the vegetable oil rich in unsaturated fatty acids is one of flaxseed oil, sunflower seed oil, perilla seed oil, peony seed oil and sacha inchi oil.

6. A preparation method of an antioxidant edible oil based on a nano reverse micelle system according to any of claim 1, comprising the following steps:
step (1): uniformly mixing a vegetable oil and an edible emulsifier, and dissolving the edible emulsifier by stirring until the system is stable, thereby obtaining a vegetable oil-edible emulsifier compound oil sample; and
step (2): adding a dried natural plant into the vegetable oil-edible emulsifier compound oil sample obtained in step (1), extracting antioxidant ingredients in the natural plant, carrying out centrifuging, and taking the supernatant.

7. The preparation method of the antioxidant edible oil based on a nano reverse micelle system according to claim 6, wherein the extraction in step (2) is one or more of stirring, ultrasound or microwave-assisted extraction.

8. The preparation method of the antioxidant edible oil based on a nano reverse micelle system according to claim 6, wherein a mass ratio of the vegetable oil to the edible emulsifier in step (1) is (10-100):1.

9. The preparation method of the antioxidant edible oil based on a nano reverse micelle system according to claim 6, wherein a mass ratio of the dried natural plant to the vegetable oil-edible emulsifier compound oil sample in step (2) is 1:(5-21).

10. The preparation method of the antioxidant edible oil based on a nano reverse micelle system according to claim 6, wherein the stirring in step (1) is carried out for 5-48 h at a speed of 500-1000 r/min; and the extraction in step (2) is carried out for 0.1-3 h.
